(19) United States
(12) Patent Application Publication
(10) Pub. No.: US 2026/0203169 A1
(43) Pub. Date: Jul. 16, 2026

(54) NODE CONFIGURATION BACKUP AND RESTORE USING NETWORK SWITCH

(71) Applicant: Dell Products L.P., Round Rock, TX (US)

(72) Inventors: Xiaofeng ZHANG, Shanghai (CN); Hong YUAN, Shanghai (CN); Jie CHEN, Shanghai (CN); Kai ZHOU, Shanghai (CN)

(73) Assignee: Dell Products L.P., Round Rock, TX (US)

(21) Appl. No.: 19/030,184

(22) Filed: Jan. 17, 2025

(30) Foreign Application Priority Data
Jan. 14, 2025 (CN) 202510055902.3

(51) Int. Cl. G06F 11/14

(52) U.S. Cl. CPC G06F 11/1451

(57) ABSTRACT

An information handling system may include a host system including a host system processor, and a management controller including a management controller processor and a management controller storage resource. The information handling system may be configured to: store critical data in the management controller storage resource; and transmit the critical data to a network switch that is communicatively coupled to the information handling system, wherein the network switch is configured to store a backup copy of the critical data.

### TECHNICAL FIELD

The present disclosure relates in general to information handling systems, and more particularly to techniques for backup up and restoring configuration information.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Hyper-converged infrastructure (HCI) is an IT framework that combines storage, computing, and networking into a single system in an effort to reduce data center complexity and increase scalability. Hyper-converged platforms may include a hypervisor for virtualized computing, software-defined storage, and virtualized networking, and they typically run on standard, off-the-shelf servers. One type of HCI solution is the Dell EMC VxRail™ system. Some examples of HCI systems may operate in various environments (e.g., an HCI management system such as the VMware® vSphere® ESXi™ environment, or any other HCI management system). Some examples of HCI systems may operate as software-defined storage (SDS) cluster systems (e.g., an SDS cluster system such as the VMware® vSAN™ system, or any other SDS cluster system).

In the HCI context (as well as other contexts), information handling systems may execute virtual machines (VMs) or containerized workloads for various purposes. A VM or container may generally comprise any program of executable instructions, or aggregation of programs of executable instructions, configured to execute a guest operating system on a hypervisor or host operating system in order to act through or in connection with the hypervisor/host operating system to manage and/or control the allocation and usage of hardware resources such as memory, central processing unit time, disk space, and input and output devices, and provide an interface between such hardware resources and application programs hosted by the guest operating system.

In both the HCI context and the non-HCI context, critical configuration data of a system is often stored in a designated region of the non-volatile storage of the system's management controller. For example, a management controller may have a small storage area (e.g., less than a megabyte in some implementations) that is available for read and write access via an API of the management controller. For example, the critical data may be stored by writing to an attribute of the management controller, which may then store the data in a storage resource such as a flash chip. The term “critical data” in this context may include any important system parameters, such as the service tag, IP address, network gateway, VLAN information, software licensing keys, and/or other information.

To ensure reliability, in existing implementations, the critical data stored in a system's management controller may be manually backed up to one or more other locations. For example, it may be manually copied to a remote network location. Then, in the event that the data is lost (e.g., if the system fails and is replaced, or if the management controller fails, or if the management controller undergoes an update, etc.), it may be manually restored from that remote location. This manual procedure is time-consuming and error prone.

Accordingly, embodiments of this disclosure provide for automatically backing up and restoring a system's critical data to and from a storage resource of a network switch to which the system is coupled. For purposes of this disclosure, the term “switch” should be understood to also include managed switches, unmanaged switches, routers, firewalls, etc.

It should be noted that the discussion of a technique in the Background section of this disclosure does not constitute an admission of prior-art status. No such admissions are made herein, unless clearly and unambiguously identified as such.

### SUMMARY

In accordance with the teachings of the present disclosure, the disadvantages and problems associated with backup and restore of configuration information may be reduced or eliminated.

In accordance with embodiments of the present disclosure, an information handling system may include a host system including a host system processor, and a management controller including a management controller processor and a management controller storage resource. The information handling system may be configured to: store critical data in the management controller storage resource; and transmit the critical data to a network switch that is communicatively coupled to the information handling system, wherein the network switch is configured to store a backup copy of the critical data.

In accordance with these and other embodiments of the present disclosure, a method may include an information handling system storing critical data in a management controller storage resource of a management controller of the information handling system, the management controller being configured to provide out-of-band management of the information handling system; and the information handling system transmitting the critical data to a network switch that is communicatively coupled to the information handling system, wherein the network switch is configured to store a backup copy of the critical data.

In accordance with these and other embodiments of the present disclosure, an article of manufacture may include a non-transitory, computer-readable medium having computer-executable instructions thereon that are executable by a processor of an information handling system for: storing critical data in a management controller storage resource of a management controller of the information handling system, the management controller being configured to provide out-of-band management of the information handling system; and transmitting the critical data to a network switch that is communicatively coupled to the information handling system, wherein the network switch is configured to store a backup copy of the critical data.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates another example information handling system, in accordance with embodiments of the present disclosure;

FIG. 3A illustrates an information handling system backing up data to a network switch, in accordance with embodiments of the present disclosure; and

FIG. 3B illustrates an information handling system restoring data from a network switch, in accordance with embodiments of the present disclosure.

### DETAILED DESCRIPTION

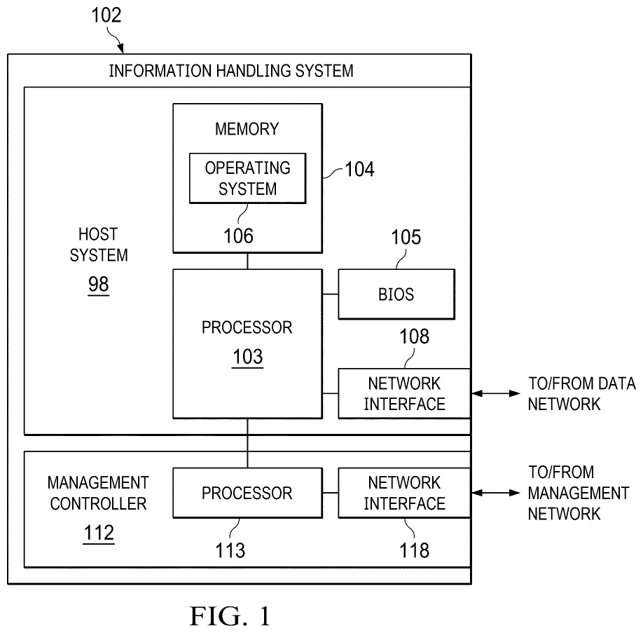

Preferred embodiments and their advantages are best understood by reference to FIGS. 1 through 3B, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, data for business, scientific, control, intelligence, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other for storing data computer-readable media (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

s shown in FIG. 1, memory 104 may have stored thereon an operating system 106. Operating system 106 may comprise any program of executable instructions for aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments system 106 may be stored in storage media operating accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface e 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

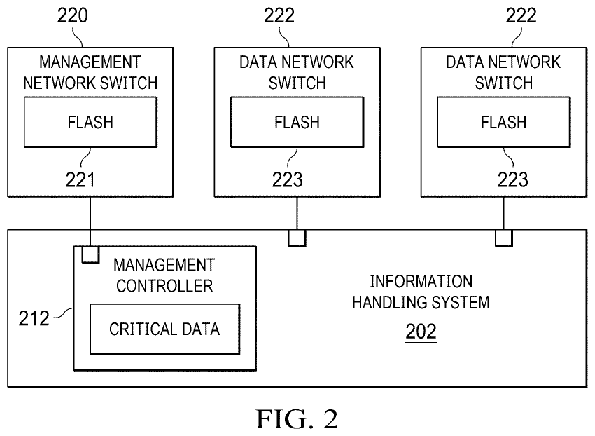

FIG. 2 shows another example information handling system 202, including management controller 212. As discussed above, information handling system 202 may store various items of critical data in a storage resource of management controller 212 (e.g., a solid-state storage resource such as a flash chip).

Information handling system 202 may include one or more in-band data network ports, which may be coupled to data network switches 222. Management controller 212 may also include its own out-of-band network port, which may be coupled to management network switch 220.

When information handling system 202 is coupled to such network switches, internal storage on those switches may be used to store backup copies of the critical data. This process may be automatically initiated by information handling system 202 or by the switch (e.g., based on a handshake that may occur when they are first connected), or it may be manually initiated by an operator. For example, in the case of a management network switch, the system's management controller may transmit the data to the switch over the out-of-band management network. In the case of a data network switch, the system's host system may transmit the data to the switch over the in-band data network.

As shown, the switches each include their own flash storage, which is typically large enough to house the critical data from several information handling systems. For example, the critical data may be small enough that all of the information handling systems coupled to a given network switch may be able to store their critical data thereon.

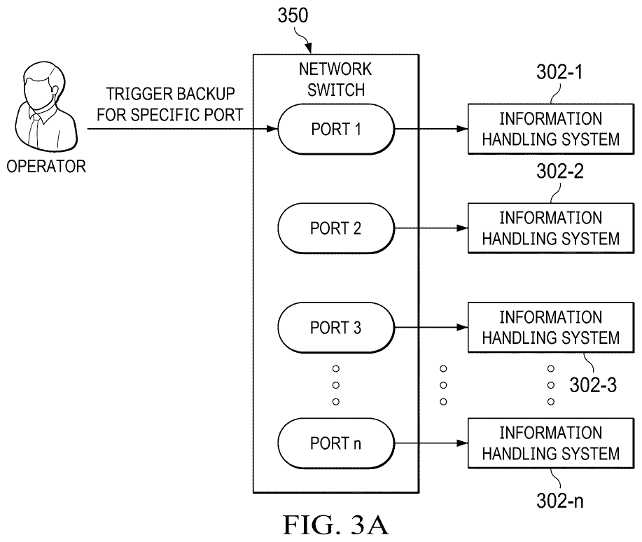

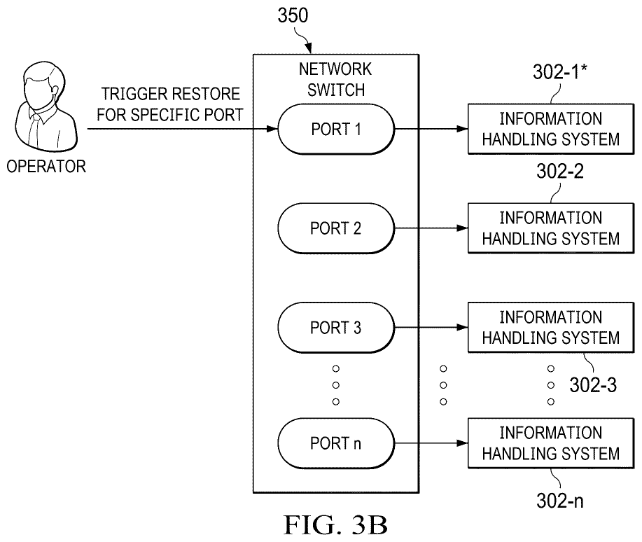

FIG. 3A illustrates an example network switch 350 which is coupled to several information handling systems 302 via its n network ports. In this example, an operator may manually trigger a backup of the critical data of an information handling system coupled to a specific port (e.g., information handling system 302-1 coupled to port 1).

Network switch 350 may then communicate with information handling system 302-1 to determine its service tag and all of the critical data stored in the designated storage region of its management controller. This data may then be pulled to the network switch and stored in its local non-volatile storage.

Table 1 below provides an example of the data that might be stored in the non-volatile storage of network switch 350 once all of the connected nodes have been polled and have provided their data.

TABLE 1

| Port | Service Tag | Critical Data |
|---|---|---|
| 1 | AAAAA | WWWWW |
| 2 | BBBBB | XXXXX |
| 3 | CCCCC | YYYYY |
| . . . | . . . | . . . |
| n | DDDDD | ZZZZZ |

Suppose that after some time passes, information handling system 302-1 fails and is replaced by a new information handling system 302-1*. Information handling system 302-1* may be similar or identical to the system it replaces, although generally the service tag will be different, and it may lack the critical data that was previously stored on the management controller of information handling system 302-1.

FIG. 3B illustrates a process for restoring that critical data from network switch onto the management controller of information handling system 302-1*. Once the new system has been installed, cabled, and powered on, the operator may initiate a restore from network switch 350 to the new management controller of the new system that is now coupled to port 1.

In particular, network switch 350 may detect that a new system has been attached to port 1. It may then request the new system's service tag, updating its stored backup data accordingly, to reflect that what was previously information handling system 302-1 is now information handling system 302-1*. Table 2 below shows the data stored in the non-volatile storage of network switch 350 after this update, with the changed element emphasized.

TABLE 2

| Port | Service Tag | Critical Data |
|---|---|---|
| 1 | AAAAB | WWWWW |
| 2 | BBBBB | XXXXX |
| 3 | CCCCC | YYYYY |
| . . . | . . . | . . . |
| n | DDDDD | ZZZZZ |

Network switch 350 may then push the critical data to information handling system 302-1*, which may store it in the designated region of its management controller's storage resource.

Once the critical data from information handling system 302-1 has been written to information handling system 302-1*, normal operations may resume.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that a structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

1. An information handling system comprising:
a host system including a host system processor; and
a management controller including a management controller processor and a management controller storage resource, the management controller being configured to provide out-of-band management of the information handling system;
wherein the information handling system is configured to:
store critical data in the management controller storage resource; and
transmit the critical data to a network switch that is communicatively coupled to the information handling system, wherein the network switch is configured to store a backup copy of the critical data.

2. The information handling system of claim 1, wherein the information handling system is a node of a hyper-converged infrastructure (HCI) system.

3. The information handling system of claim 1, wherein the network switch is an out-of-band management network switch communicatively coupled to the management controller.

4. The information handling system of claim 1, wherein the network switch is an in-band data network switch communicatively coupled to the host system.

5. The information handling system of claim 1, wherein the network switch is a router.

6. The information handling system of claim 1, wherein the critical data includes a service tag of the information handling system, a network address of the information handling system, a network gateway address, and at least one software licensing key.

7. A method comprising:
an information handling system storing critical data in a management controller storage resource of a management controller of the information handling system, the management controller being configured to provide out-of-band management of the information handling system; and
the information handling system transmitting the critical data to a network switch that is communicatively coupled to the information handling system, wherein the network switch is configured to store a backup copy of the critical data.

8. The method of claim 7, wherein the information handling system is a node of a hyper-converged infrastructure (HCI) system.

9. The method of claim 7, wherein the network switch is an out-of-band management network switch communicatively coupled to the management controller.

10. The method of claim 7, wherein the network switch is an in-band data network switch communicatively coupled to a host system of the information handling system.

11. The method of claim 7, wherein the network switch is a router.

12. The method of claim 7, wherein the critical data includes a service tag of the information handling system, a network address of the information handling system, a network gateway address, and at least one software licensing key.

13. An article of manufacture comprising a non-transitory, computer-readable medium having computer-executable instructions thereon that are executable by a processor of an information handling system for:
storing critical data in a management controller storage resource of a management controller of the information handling system, the management controller being configured to provide out-of-band management of the information handling system; and
transmitting the critical data to a network switch that is communicatively coupled to the information handling system, wherein the network switch is configured to store a backup copy of the critical data.

14. The article of manufacture of claim 13, wherein the information handling system is a node of a hyper-converged infrastructure (HCI) system.

15. The article of manufacture of claim 13, wherein the network switch is an out-of-band management network switch communicatively coupled to the management controller.

16. The article of manufacture of claim 13, wherein the network switch is an in-band data network switch communicatively coupled to a host system of the information handling system.

17. The article of manufacture of claim 13, wherein the network switch is a router.

18. The article of manufacture of claim 13, wherein the critical data includes a service tag of the information handling system, a network address of the information handling system, a network gateway address, and at least one software licensing key.

19. The information handling system of claim 1, wherein the information handling system is communicatively coupled to the network switch via a selected port of the network switch, and wherein the network switch is further configured to:
in response to the information handling system being replaced by a replacement information handling system, transmit the critical data to the replacement information handling system via the selected port.
